(19) United States
(12) Patent Application Publication
(10) Pub. No.: US 2021/0192578 A1
(43) Pub. Date: Jun. 24, 2021

(54) IDENTIFYING ADVERTISEMENTS FOR A MOBILE DEVICE

(71) Applicant: International Business Machines Corporation, Armonk, NY (US)

(72) Inventors: Lenin Mehedy, Doncaster East (AU); Cristian VECCHIOLA, Victoria (AU)

(21) Appl. No.: 16/723,869

(22) Filed: Dec. 20, 2019

(51) Int. Cl. G06Q 30/02

(52) U.S. Cl. CPC G06Q 30/0271; G06Q 30/0267; G06Q 30/0261

(57) ABSTRACT

Method and apparatus for identifying an advertisement based on a location of advertisements stored within an advertisement database. An advertisement engine is configured to generate a query comprising a geographical zone identified using user data received from a mobile device. The user data comprises a location and an orientation of the mobile device. The advertisement engine is further configured to identify one or more advertisements of the plurality of advertisements that are within the geographical zone by comparing the locations of the plurality of advertisements to the geographical zone. Further, the advertisement engine is configured to communicate information corresponding to the identified one or more advertisements to the mobile device.

### BACKGROUND

The present invention relates to interacting with advertisements, and more specifically, to communicating advertisement information to mobile devices.

Out-of-home advertisements present a large amount of information to commuters and travelers. However, commuters and travelers commonly do not have enough time to collect information regarding advertisements that they would like to act on or follow up with. For example, commuters utilizing public transportation (e.g., a train, bus, or tram) are moving quickly and advertisements may leave a commuter's field of visibility in a short period of time. Accordingly, it is difficult for someone taking public transportation to identify an advertisement that they are interested in and record details of the advertisement before the advertisement is no longer visible. This issue is exasperated when dealing with multiple advertisements that are visible at one time.

Thus, there is a need for an improved system for capturing information of advertisements such that the advertisements deemed to be interesting to a user may be acted on or followed up with.

### SUMMARY

According to one embodiment of the present invention, an advertisement identification system comprises an advertisement database storing locations of a plurality of advertisements, and an advertisement engine. The advertisement engine is configured to generate a query comprising a geographical zone identified using user data received from a mobile device. The user data comprises a location and an orientation of the mobile device. The advertisement engine is further configured to identify one or more advertisements of the plurality of advertisements that are within the geographical zone by comparing the locations of the plurality of advertisements to the geographical zone. Further, the advertisement engine is configured to communicate information corresponding to the identified one or more advertisements to the mobile device.

According to one embodiment of the present invention, a method for identifying an advertisement comprises generating a query comprising a geographical zone based on user data received from a mobile device. Wherein the user data comprises a location and orientation of the mobile device. The method further comprises identifying one or more advertisements by comparing a location each of a plurality of advertisements to the geographical zone of the query. Further, the method comprises communicating information corresponding to the identified one or more advertisements to the mobile device.

According to one embodiment of the present invention, a mobile device comprises a display and a controller. The controller is configured to determine a gesture from input data, communicate an orientation of the mobile device and a location of the mobile device to an advertisement identification system in response to determining the gesture from the input data, and receive information corresponding to one or more advertisements from the advertisement identification system. The one or more advertisements are identified using the orientation and the location of the mobile device. The controller is further configured to display, on the display, one or more display elements in response to receiving the information corresponding to the one or more advertisements.

### BRIEF DESCRIPTION OF THE SEVERAL VIEWS OF THE DRAWINGS

FIG. 1 is a schematic illustration of a mobile device and an advertisement identification system, according to one or more embodiments.

FIG. 2 is a flow chart of a method of communicating user data from a mobile device to an advertisement identification system, according to one or more embodiments.

FIG. 3 is a flow chart of a method of identifying advertisements, according to one or more embodiments.

FIG. 4 illustrates a geographical zone utilized for identifying advertisements, according to one or more embodiments.

FIG. 5 illustrates a mobile device displaying display elements corresponding to one or more advertisements, according to one or more embodiments.

### DETAILED DESCRIPTION

Embodiments herein describe various systems and methods for capturing information of advertisements on a mobile device. In one embodiment, user data of a user of a mobile device is used to generate a query. The query is used to identify advertisements. For example, the query may include a geographical zone that corresponds to a location and orientation of a mobile device. Information related to the advertisements that are identified as to being within the geographical zone is communicated to the mobile device. The mobile device may display the information to a user such that the user may act on or follow up with the advertisements.

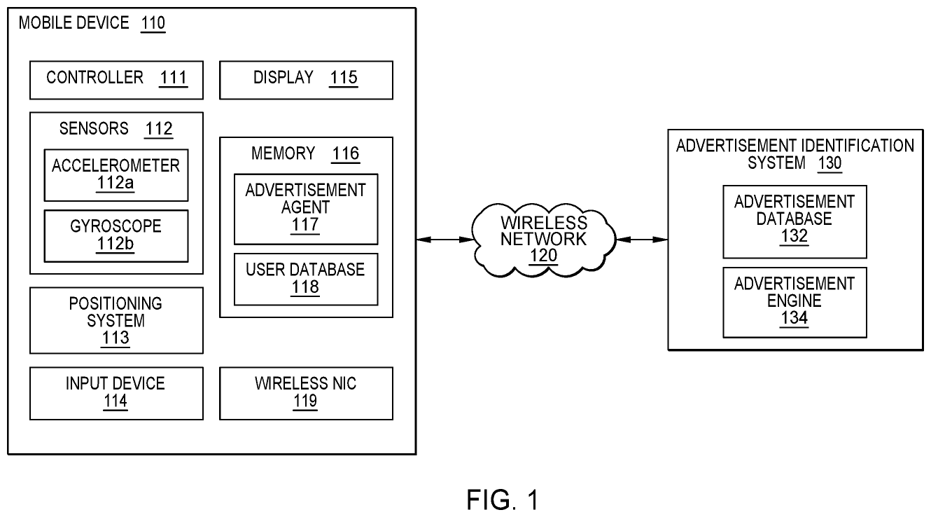

With reference now to FIG. 1. FIG. 1 illustrates an advertisement identification system 130, according to one or more embodiments. The advertisement identification system 130 may be communicatively coupled with one or more mobile devices (e.g., mobile device 110) via one or more wireless networks (e.g., the wireless network 120). The advertisement identification system 130 receives user data from the one or more mobile devices, identifies one or more advertisements based on the user data, and communicates the information corresponding to the identified advertisements to the one or more mobile devices.

The advertisement identification system 130 may include one or more processors and memory elements. The processors may be any general processing device, such as a central processing unit (CPU). In one embodiment, one or more of the memory elements include computer usable program code that may be executed by one or more processors of the advertisement identification system 130 to perform the various functions of the advertisement identification system 130. The computer usable program code may include instructions executable by one or more of the processors of the advertisement identification system 130. In one or more embodiments, the advertisement identification system 130 is a server computer device. Further, the advertisement identification system 130 may be configured to operate within a cloud computing system. In such an embodiment, the advertisement identification system 130 may operate within one or more virtual computing resources of a cloud computing provider.

The advertisement identification system 130 includes an advertisement database 132 and an advertisement engine 134. The advertisement database 132 may be located within one or memories of the advertisement identification system 130. The advertisement database 132 includes information corresponding to a plurality of advertisements. For example, the advertisement database 132 may include one or more of identification information, a description, keywords, an advertisement type, a web address, contact information, personalization information, location, creation date, and expiration date. The data within the advertisement database 132 may be populated by analyzing the advertisement data stored within a company profile database and/or manually entered into the advertisement database 132. In one embodiment, the advertisement identification system 130 analyzes a company profile database to generate the data within the advertisement database 132. Additionally, or alternatively, the advertisement identification system 130 requests additional information from one or more companies to populate the data within the advertisement database 132. In various embodiments, the location of an advertisement may be manually entered. For example, the coordinate location of the advertisement may be manually provided to the advertisement identification system 130. In one embodiment, a user selects the location of the advertisement on a map. Further, an advertisement may be equipped with one or more sensors which may be used to report the location of the advertisement to the advertisement identification system 130. Further the sensors may be used to report which advertisement is being display and the frequency that an advertisement is displayed, among others. In embodiments where the advertisement type is non-stationary, the location of the advertisement may be dynamically updated. For example, the location of the advertisement may be updated based on data from one or more sensors attached to the advertisement. In one or more embodiments, the location of the advertisement may be registered within a train, train car, bus, or tram.

The identification information includes at least one of a name of the entity corresponding to the advertisement. The entity may include a business, organization, or group, among others. The description can include descriptive text describing the advertisement, the entity, or a tagline. The keywords are single words or phrases that may be used by the advertisement engine 134 or a search engine to find the advertisement.

The advertisement type describes the physical type of advertisement. For example, the advertisement type may correspond to a type of out-of-home (OOH) advertisement, such a billboard, transit advertisement, and street furniture advertisement. Further, the advertisement type may correspond to shopping mall displays, building-front displays, etc. In various embodiments, the advertisement type may include non-stationary displays. For example, the advertisement type may include advertisements on transit vehicles (e.g., busses, trains, trams, trucks, bikes, etc.) Billboard advertisements are outdoor advertisements that are typically large in size. Billboard advertisements are stationary and may be free standing or mounted to a side of a building or structure. Further billboard advertisements may include printed elements (or static elements) and/or digital elements. For example, a billboard advertisement may include printed elements that do not change over the lifetime of the advertisement. The printed elements may include pictures and text and may be mounted to the billboard. Alternatively, or additionally, a billboard advertisement may include one or more digital elements that may include video or series of changing images. Transit advertisements include printed elements and/or digital elements. Further, transit advertisements may be stationary and located in or around transit stations and platforms. For example, a transit advertisement may be located in or around a bus station or platform or a train station or platform. Further, as with billboard advertisements, transit advertisements include printed elements and/or one or more digital elements. Street furniture advertisements include printed elements and/or digital elements and may be placed on bus shelters, news racks, mall kiosks, and telephone booths, among others. Further, as with billboard advertisements, street furniture advertisements include printed elements and/or one or more digital elements.

In various embodiments, the advertisement type is a digital advertisement and configured to rotate between multiple different advertisements over a period of time. The digital advertisements may include one or display elements (e.g., monitors). Further, advertisement database 132 may include an indication that the advertisement type is a digital advertisement. For example, the advertisement database 132 may include a flag or a subtype that may be used to determine whether or not that the advertisement is a digital advertisement. Further, the advertisement database 132 includes a frequency or timing of when the corresponding advertisement is displayed. For example, the advertisement database 132 may include an entry that an advertisement is displayed once every “X” seconds or minutes, where “X” has a value of one or greater. Further, the advertisement database 132 may include may include an entry that an advertisement is displayed at over a specific time period. For example, an advertisement may be displayed during different time periods on different days. During weekdays an advertisement may be displayed during heavy commuting hours or over a period of time that coincide with lunch breaks of nearby commuters. For example, an advertisement may be displayed when users may be commuting to or from work, a lunch period, or dinner period, among others.

In one embodiment, the web address is a uniform resource locator (URL) of a web resource the advertisement references. For example, the web address may correspond to a website for the entity of a corresponding advertisement. Alternatively, the web address may correspond to a video or other multimedia element for the entity of a corresponding advertisement.

The contact information for the advertisement may include a phone number, a social media username (or handle), and/or an email address, among others. The personalization information of an advertisement may correspond to a URL of a website that may be adapted based on one or more attributes of a user and/or a mobile device. The location information corresponds to the physical location of an advertisement. The location may be stored as a longitude and latitude. However, in other embodiments, the location may correspond to other coordinate systems. The creation date corresponds to when an advertisement was created or made available to the public. For example, the creation data may correspond to a date when an advertisement is installed on a billboard. Further, the expiration date corresponds to when an advertisement has or will be removed. For example, the expiration date corresponds to when an advertisement has or will be removed from a billboard.

The advertisement engine 134 identifies advertisements based on user data received from the mobile device 110. For example, the advertisement engine 134 processes the user data to generate a query, searches the advertisement database 132 based on the query to identify one or more advertisements, and communicates information related to the identified one or more advertisements to the mobile device 110 via the wireless network 120. The query comprises at least a geographical zone corresponding to the mobile device 110. In one embodiment, the advertisement engine 134 communicates with the wireless network via one or more wireless network interface controllers (NICs).

In one embodiment, the advertisement database 132 is part of a different computer system than that of the advertisement engine 134. For example, the advertisement database 132 may be provided by a first provider and the advertisement engine 134 may be provided by a second provider. In another embodiment, the advertisement database 132 is provided by the same provider as the advertisement engine 134.

The mobile device 110 may be a mobile phone, a tablet device, a wearable device, and a laptop. The mobile device 110 includes a controller 111, sensors 112, a display 115 and a memory 116. The controller 111 may be any general purpose processor. For example, the controller 111 may be a central processing unit (CPU) of the mobile device 110. The controller 111 may be communicatively coupled with the memory 116. The memory 116 is a computer readable storage medium and stores an advertisement agent 117 and a user database 118. The user database 118 includes information corresponding to a user of the mobile device 110 and/or features of the mobile device 110. For example, the user database 118 may include information regarding one or more preferences, attributes, and/or accessibility parameters of the user of the mobile device 110 and/or attributes of the mobile device 110. The advertisement agent 117 receives user data from the sensors 112 and/or the user database 118, communicates the user data to the advertisement identification system 130, and generates a display based on the information received from the advertisement identification system 130. In one embodiment, the mobile device 110 includes a wireless NIC 119 and the controller 111 communicates with the wireless network 120 via the wireless NIC 119.

The sensors 112 include one or more of an accelerometer 112a and a gyroscope 112b. Further, the sensors 112 may include sensors in addition to, or alternatively to, the accelerometer 112a and/or the gyroscope 112b. In one embodiment, the sensors 112 include both the accelerometer 112a and the gyroscope 112b. The accelerometer 112a and the gyroscope 112b obtain sensor data that may be utilized to determine orientation of the mobile device 110. For example, the accelerometer 112a obtains sensor data that corresponds to acceleration forces of the mobile device 110. Further, the gyroscope 112b obtains sensor data that corresponds to angular velocity of the mobile device 110. The controller 111 receives the sensor data from one or more of the accelerometer 112a and the gyroscope 112b, processes the sensor data, and determines an orientation of the mobile device 110 from the processed sensor data. In various embodiments, the orientation of the mobile device 110 may correspond to a heading of the mobile device 110 (e.g., a direction the mobile device is pointing).

The positioning system 113 obtains location data that may be utilized by the controller 111 to determine a location of the mobile device 110. For example, the positioning system 113 may be a global positioning service (GPS) radio that communicates with one or more GPS satellites to obtain location information. Additionally, or alternatively, the positioning system 113 may obtain location information determined from the multilateration of radio signals between two or more cell towers of the wireless network 120. The location information may be communicated to the controller 111 which determines a latitudinal and longitudinal position of the mobile device 110. In other embodiments, the location information may be utilized to determine the location of the mobile device 110 according to other coordinate systems. In other embodiments, a camera of the mobile device 110 may be utilized to capture one or more images of the area surrounding the mobile device 110. The images may be analyzed and compared to a database of geographical to identify the location of the mobile device 110. In one or more embodiments, the location information of the mobile device 110 may include transit information. For example, the location information of the mobile device 110 may include a train and/or a train car of a train. Further, the location information of the mobile device 110 may include a bus or tram.

The input device 114 may be a touch sensor (touch interface), a mouse, or keyboard, among others. The input device 114 receives input provided by a user which may be used by the controller 111 to initiate communication with the advertisement identification system 130. For example, the input device 160 may be a touch sensor that acquires input data (e.g., location and/or movement data) for one or more input objects (e.g., a user's digits or a stylus) and based on the input data, user data may be communicated from the mobile device 110 to the advertisement identification system 130. Alternatively, the input device 114 may be an infrared (IR) sensor, or another proximity sensing device, which may be utilized to acquire sensor data indicative of a change in position of an input object. In one embodiment, a gesture is determined by the controller 111 based on the input data acquired from the input device 114.

The display 115 displays information corresponding to one or more advertisements to the user of the mobile device 110. The display 115 may be a liquid crystal display (LCD) device or an organic light emitting diode (OLED) display device that displays one or more advertisements or other information to a user of the mobile device provided by the controller 111. In one embodiment, a user interface (UI) corresponding to the advertisement agent 117 is displayed on the display 115. In such embodiments, display elements corresponding to the identified advertisements are displayed within the UI of the advertisement agent 117.

The user database 118 includes user data of the user of the mobile device 110. The user data may include preferences, attributes, and/or accessibility parameters of the user of the mobile device 110. Further, the user data may additionally, or alternatively, include attributes of the mobile device 110. The attributes of the user may include whether or not a user is color blind, range of colors visible to a user, whether or not a user wears corrective lenses, and the strength of the prescription of corrective lenses, among others. The preferences of the user may include the advertisements or types of advertisements the user has previously interacted with or not interacted with. For example, the preferences of the user may indicate that a user has interacted with advertisements corresponding to charities, a type of product, and/or a type of service. Further, the user preferences may include a radius of a geographical zone used when identifying advertisements. The attributes of the mobile device 110 may include an operating system of the mobile device and the size and/or resolution of the display of the mobile device, among others. In various embodiments, the user data additionally includes the time of day. The accessibility parameters may correspond to how a user is able to interact with a mobile device. In one embodiment, the accessibility parameters may correspond to areas of the display 115 that are not reachable by a user's thumb when using the mobile device with a single hand.

The wireless network 120 includes one or more of a mobile communication network (e.g., a cellular network), a wireless local area network (WLAN), and near-field communication (e.g., Bluetooth or Zigbee). Further, the wireless network 120 may include one or more antennas, routers, and/or modems that communicate with the mobile device 110 and the advertisement identification system 130.

In various embodiments, while FIG. 1 illustrates a single mobile device 110, the advertisement identification system 130 communicates with one or more mobile devices simultaneously. For example, the advertisement identification system 130 may receive user data from multiple different mobile devices, identify advertisements for each respective mobile device based on the respective user data, and communicate information corresponding to the identified advertisements to each respective mobile device. In such embodiments, one or more receiving sensor data from multiple different mobile devices, identifying advertisements for each respective mobile device based on the respective user data, and communicating information corresponding to the identified advertisements to each respective mobile device may occur during at least partially overlapping periods of time.

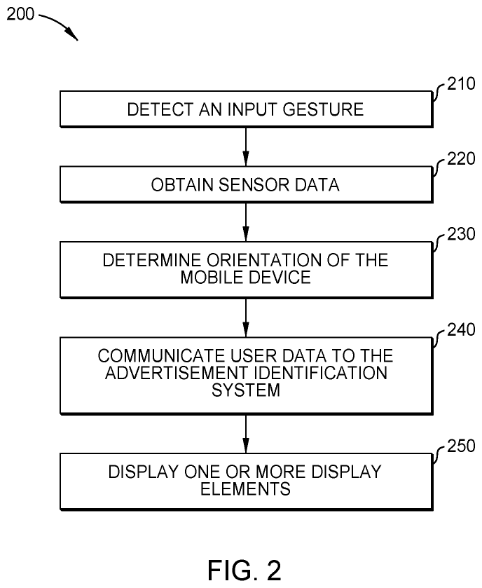

FIG. 2 is a flow chart of a method 200 for presenting an advertisement to a user of a mobile device (e.g., the mobile device 110). At operation 210, the mobile device 110 detects an input gesture indicating an acquisition of an advertisement. For example, the input device 114 obtains input data and communicates the input data to the controller 111. The input data may indicate a change in position of an input object of the user with regard to the mobile device 110. For example, the input data may indicate that a finger of a user moved from a top portion of the mobile device 110 toward a bottom portion of the mobile device 110. Such a gesture may be referred to as a swipe down or slide in gesture. Alternatively, the input data may be captured from one or more of the accelerometer 112a and the gyroscope 112b. Accordingly, the input data may indicative of a top of the mobile device 110 being moved away from the user. Further, the input device 114 may be a microphone and the input data may correspond to voice data. The controller 111 may process the input data to determine a voice command which may be used in addition to or alternatively to the gesture. In one embodiment, the advertisement agent 117 is launched before performing the input gesture. In such an embodiment, the advertisement agent 117 executes in the foreground or in the background. Alternatively, the user performs the input gesture before launching the advertisement agent 117. In such an embodiment, detection of the input gesture may launch the advertisement agent 117.

At operation 220, the controller 111 obtains sensor data from the sensors 112. For example, the controller 111 obtains sensor data from at least one of the accelerometer 112a and the gyroscope 112b. In one embodiment, the controller 111 obtains sensor data from the accelerometer 112a and the gyroscope 112b. Further, the controller 111 may obtain sensor data from the positioning system 113 and determines the location of the user from the sensor data from the positioning system 113.

At operation 230, the controller 111 determines the orientation of the mobile device 110 based on the sensor data received from the sensors 112. For example, the controller 111 determines the orientation of the mobile device 110 based on the senor data received from the accelerometer 112a and the sensor data from the gyroscope 112b. Determining the orientation of the mobile device 110 comprises determining a direction the mobile device 110 is pointing. For example, the controller 111 processes the sensor data to determine a change in rotation of the mobile device 110 about one or more axes of the mobile device 110. Further, the orientation of a device may be a cardinal direction. Alternatively, the orientation may be another directional system. In one embodiment, the sensor data may be received from a wearable device. For example, the sensor data may be received from smart glass or augmented reality (AR) goggles. In such embodiments, the wearable device may track the movement of a user's head and/or eyes which may be reported as sensor data to the controller 111.

At operation 240, the mobile device 110 communicates user data to the advertisement identification system 130. For example, the user data includes one or more of the location of the mobile device 110, the orientation of the mobile device 110, preferences of a user of the mobile device 110, attributes of the user of the mobile device 110, and attributes of the mobile device 110. In one embodiment, in response to detection of the input gesture, the controller 111 communicates the user data to the advertisement identification system 130 via the wireless network 120. For example, in response to detection of the input gesture, the controller 111 communicates a location of the mobile device 110 and the orientation of the mobile device 110 to the advertisement identification system 130. Further, the controller 111 may access user attributes and/or user preferences from the user database 118 and communicates the user attributes and/or user preferences to the advertisement identification system 130.

At operation 250, the mobile device 110 displays one or more display elements. For example, the controller 111 receives information corresponding to one or more advertisements identified by the advertisement engine 134 and instructs the display 115 to display the one or more display elements. Each displayed display element corresponds to a different identified advertisement and comprises information corresponding to the identified advertisement. Further, the displayed elements may be displayed within the user interface of the advertisement agent 117. Additionally, the controller 111 may receive input data from the input device 114 and save and/or delete information corresponding to one or more advertisements based the input data. For example, the controller 111 may save information corresponding to one or more advertisements within the memory 116 in response to input data received from the input device 114. In various embodiments, the saved information may be used to determine a user's preference and to narrow or focus a search for advertisements based on the user's preferences. Further, the controller 111 may delete information corresponding to one or more advertisements in response to input data received from the input device 114.

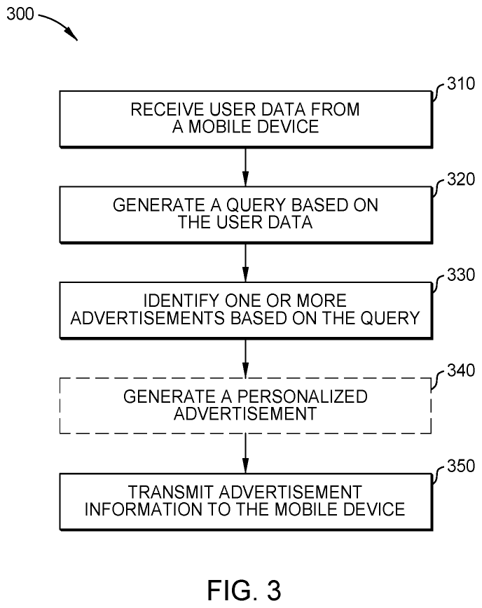

FIG. 3 is a flow chart of a method 300 for identifying advertisements, according to one or more embodiments. At operation 310, the advertisement identification system 130 receives user data from the mobile device 110. For example, the user data may be received via the wireless network 120. At operation 320, the advertisement engine 134 generates a query based on the user data. For example, the query may include a geographical zone or the advertisement engine 134 may generate the geographical zone based on the user data. The advertisement engine 134 may generate a geographical zone as part of the query based on at least one of the location and the orientation of the mobile device 110. Further, the query may include a field of view which may be generated as part of the geographical zone based on the orientation of the mobile device 110.

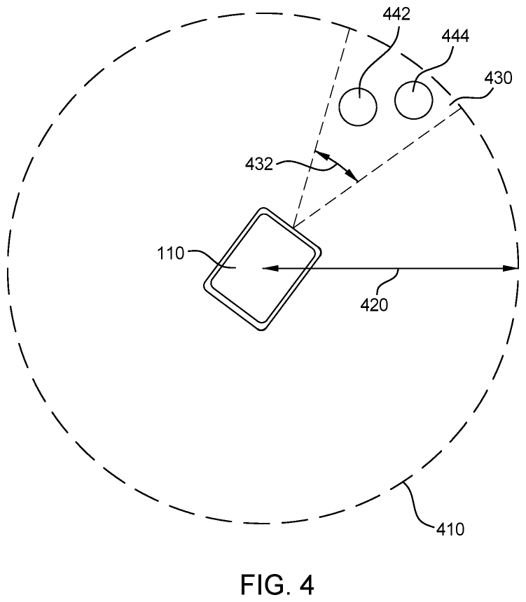

FIG. 4 illustrates a geographical zone 410 determined from the location and/or orientation of the mobile device 110. The geographical zone 410 is circular having a radius 420. The geographical zone 410 is determined from the location of the mobile device 110. For example, the geographical zone 410 may be determined by generating a geographical zone 410 with radius 420 about the location of the mobile device 110. Although the geographical zone 410 is shown as being circular in shape, the geographical zone 410 may have other shapes. For example, the geographical zone 410 may be a polygon denoting a region to be searched. In various embodiments, the geographical zone 410 may be an irregular shape based on one or more real world geographical features. For example, in one embodiment, an orientation of a user may be directed to a river and the shape of the geographical zone 410 may have an irregular shape indicated the land area around the river. The radius 420 may be provided by a user via the user data or may be provided by the advertisement identification system 130. In one embodiment, the radius is selected within the advertisement agent 117 by a user of the mobile device 110 and provided to the advertisement identification system 130 as part of the user data. The advertisement engine 134 generates the geographical zone 410 by determining the location of the mobile device 110 and determining a zone with the radius 420 and centered about the location of the mobile device 110. In other embodiments, the location of the mobile device 110 is not at the center of the geographical zone 410. For example, the geographical zone 410 may be centered about a location that is a first distance from the mobile device 110. The first distance may be included within the user data provided by the mobile device 110 or stored within the advertisement identification system 130.

A field of view 430 within the geographical zone 410 is determined from at least the orientation of the user. The field of view 430 has an angle 432. The angle 432 may be included within the user data provided by the mobile device 110 or stored within the advertisement identification system 130. In one embodiment, the angle 432 of the field of view 430 is selected from within the advertisement agent 117 by a user of the mobile device 110 and provided to the advertisement identification system 130 as part of the user data. The field of view 430 is a portion of the geographical zone 410. In embodiment, the area of the field of view 430 is less than the area of the geographical zone 410. In another embodiment, the area of the field of view 430 may be equal to that of the geographical zone 410. Further, the area of the field of view 430 may be described as a set of coordinates. For example, the boundaries of the field of view 430 may correspond to sets of latitudinal and longitudinal coordinates.

At operation 330, the advertisement engine 134 identifies one or more advertisements based on the query. For example, the advertisement engine 134 may search the advertisement database 132 to identify one or more advertisements that have a location within the geographical zone 410. The advertisement engine 134 may compare the location of each advertisement within the advertisement database 132 to the coordinates of a field of view within a geographical zone of the query to identify one or more advertisements to present to the user of the mobile device 110. With reference to FIG. 4, the advertisement engine 134 compares the location each of advertisement to coordinates of the field of view 430 within the geographical zone 410 to determine whether an advertisement is located within the field of view 430. Advertisements determined to be located within the field of view 430 may be flagged or some other way indicated as being within the field of view 430. As illustrated in FIG. 4, the advertisements 442 and 444 are determined to be located within the field of view 430. In one embodiment, the advertisement engine 134 identifies stationary and non-stationary advertisements within the geographical zone 410. For example, the advertisement engine 134 identifies non-stationary advertisements that move within the geographical zone 410 or move out of the geographical zone 410.

In one embodiment, the advertisement engine 134 may further identify advertisements based the user data provided by the mobile device 110. For example, the advertisement engine 134 may exclude one or more advertisements based on the historical data corresponding to the user. The historical data may signify that the user ignored or blocked a certain type of advertisements. Accordingly, the advertisement engine 134 may exclude advertisements having a type that has been previously ignored or blocked by a user. For example, the advertisement engine 134 may compare the type of advertisement of the advertisements 442 and 444 to the historical data and exclude one or more of the advertisements 442 and 444 when an advertisement is determined to have a type that matches a type of advertisement that was previously ignored or blocked by a user.

At operation 340, the advertisement engine 134 generates personalized data for each of the identified advertisements 442 and 444. The personalized data is communicated to the mobile device 110 and is utilized when displaying a corresponding display element. The advertisement engine 134 may alter the font size, alter one or more colors to be displayed on the mobile device 110, and/or set a size of the corresponding advertisement to be displayed on the mobile device 110. Further, the advertisement engine 134 may determine the type of information to be displayed on the mobile device 110. In one example, the advertisement engine 134 determines that the user of the mobile device 110 has a preferred text size of at least 14 point and is unable to distinguish green and red. Accordingly, the advertisement engine 134 may generate personalized data indicating a text size of at least 14 and the omission of green or red. In various embodiments, the operation 340 is optional and may be omitted.

At operation 350, the advertisement engine 134 transmit information corresponding to the identified advertisements to the mobile device 110. For example, the advertisement engine 134 transmits information corresponding to the advertisements 442 and 444. The information corresponding to the advertisements may include information to be displayed on the display 115. For example, the information may include one or more of an entity name, an image, a URL, a description, and a tagline to be displayed on the display 115. Further, the information may further include the personalized data. The controller 111 instructs the display 115 to display the information corresponding to the one or more identified advertisements communicated by the advertisement engine 134. The information corresponding to the one or more advertisements is displayed as display elements on the within the user interface of the advertisement agent 117. In one embodiment, the information corresponding to the one or more advertisements is stored within the memory 116.

The advertisement engine 134 may store the advertisements or information corresponding to the identified advertisements within a memory of the advertisement identification system 130 before transmitting the information to the mobile device 110.

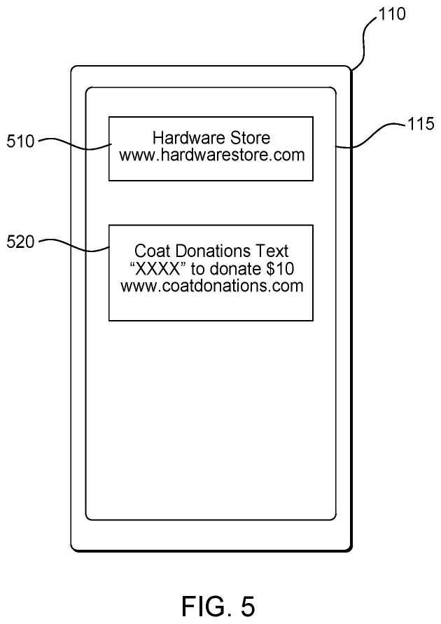

FIG. 5 illustrates the mobile device 110 having the display elements 510 and 520 corresponding to the identified advertisements (e.g., the advertisements 442 and 444) displayed thereon. The display elements 510 and 520 may be displayed by the display 115 within the advertisement agent 117 running on the mobile device 110. As illustrated, the display elements 510 and 520 include an entity name and a web address for the entity. The display elements 510 and 520 may display the same types of information or different types of information. For example, Further, the display element 520 includes a tagline “Text “XXXX” to donate $10” while the display element 510 does not include a tagline. In other embodiments, both the display elements 510 and 520 may include the same entries. Further, the display elements 510 and 520 may include types of information not illustrated in FIG. 5. For example, the display elements 510 and 520 may include contact information. Further, the display elements 510 and 520 may have different colors. For example, the display elements 510 and 520 may have different colors based on a user's color vision profile. Alternatively, the elements 510 and 520 may have different colors based on one or features of the corresponding advertisement. Further, the display elements 510 and 520 may be displayed on the display 115 based on a user's preferences to exclude a portion of the display 115. For example, the portion of the display 115 may be excluded to avoid an area that is inaccessible to a user. A region that is inaccessible to a user may correspond to a region of the display that is not easily reached during use by a user.

In various embodiments, one or more of the display elements 510 and 520 are saved to the memory 116. For example, a user may select one or more of the display elements 510 and 520 to be stored within the memory 116 such that they may be viewed and/or acted on at a later time. Alternatively, both of the display elements 510 and 520 are saved to the memory 116 in response to being displayed and/or received from the advertisement engine 134 and accessible via the user interface of the advertisement agent 117. Further, a user may remove one or more of the display elements 510 and 520 from the memory 116 via the user interface of the advertisement agent 117.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., the advertisement engine 134) or related data available in the cloud. For example, the advertisement engine 134 could execute on a computing system in the cloud and to identify one or more advertisements based on user data. In such a case, the advertisement engine 134 could generate a query and store identified advertisements at a storage location in the cloud. Doing so allows a user to access this information from any computing system attached to a network connected to the cloud (e.g., the Internet).

While the foregoing is directed to embodiments of the present invention, other and further embodiments of the invention may be devised without departing from the basic scope thereof, and the scope thereof is determined by the claims that follow.

What is claimed is:

1. An advertisement identification system, comprising:
an advertisement database storing locations of a plurality of advertisements; and
an advertisement engine configured to:
generate a query comprising a geographical zone identified using user data received from a mobile device, wherein the user data comprises a location and an orientation of the mobile device;
identify one or more advertisements of the plurality of advertisements that are within the geographical zone by comparing the locations of the plurality of advertisements to the geographical zone; and
communicate information corresponding to the identified one or more advertisements to the mobile device.

2. The advertisement identification system of claim 1, wherein the geographical zone corresponds to the location of the mobile device.

3. The advertisement identification system of claim 2, wherein generating the query further comprises generating a field of view within the geographical zone based on the orientation of the mobile device.

4. The advertisement identification system of claim 3, wherein identifying the one or more advertisements of the plurality of advertisements that are within the geographical zone comprises comparing the location of each of the plurality of advertisements to the field of view.

5. The advertisement identification system of claim 1, wherein the user data further comprises one or more user attributes, and wherein advertisement engine is further configured to generate personalized data for each of the identified one or more advertisements based on the one or more user attributes.

6. The advertisement identification system of claim 1, wherein the user data further comprises one or more user preferences, and wherein the advertisement engine is further configured to omit one or more advertisements by comparing a type of each of the plurality of advertisements to the one or more user preferences and accessibility parameters.

7. The advertisement identification system of claim 1, wherein the orientation of the mobile device corresponds to a heading of the mobile device.

8. The advertisement identification system of claim 1, wherein the geographical zone comprises a radius and is centered about the location of the mobile device.

9. A method for identifying advertisements, the method comprising:
generating a query comprising a geographical zone based on user data received from a mobile device, wherein the user data comprises a location and orientation of the mobile device;
identifying one or more advertisements by comparing a location each of a plurality of advertisements to the geographical zone of the query; and
communicating information corresponding to the identified one or more advertisements to the mobile device.

10. The method of claim 9, wherein the geographical zone corresponds to the location of the mobile device.

11. The method of claim 10, wherein generating the query further comprises generating a field of view within the geographical zone based on the orientation of the mobile device.

12. The method of claim 11, wherein identifying the one or more advertisements by comparing the location each of the plurality of advertisements to the geographical zone comprises comparing the location of each of the plurality of advertisements to the field of view.

13. The method of claim 9 further comprises generating personalized data for each of the identified one or more advertisements based on one or more user attributes of the user data.

14. The method of claim 9 further comprises wherein omitting one or more advertisements by comparing a type of each of the plurality of advertisements to one or more user preferences of the user data.

15. The method of claim 9, wherein the geographical zone comprises a radius and is centered about the location of the mobile device.

16. A mobile device comprising:
a display; and
a controller configured to:
determine a gesture from input data;
communicate an orientation of the mobile device and a location of the mobile device to an advertisement identification system in response to determining the gesture from the input data;
receive information corresponding to one or more advertisements from the advertisement identification system, wherein the one or more advertisements are identified using the orientation and the location of the mobile device; and
display, on the display, one or more display elements in response to receiving the information corresponding to the one or more advertisements.

17. The mobile device of claim 16 further comprising an input device configured to acquire the input data.

18. The mobile device of claim 16 further comprising one or more sensors configured to acquire sensor data, and wherein the controller is further configured to determine the orientation of the mobile device from the sensor data.

19. The mobile device of claim 16 further comprising a positioning system configured to acquire location data, and wherein the controller is further configured to determine the location of the mobile device from the location data.

20. The mobile device of claim 16, wherein the one or more advertisements are determined to be within a geographical zone determined based on the location of the mobile device.
